(19) United States
(12) Patent Application Publication
(10) Pub. No.: US 2012/0092316 A1
(43) Pub. Date: Apr. 19, 2012

(54) LIQUID CRYSTAL DISPLAY DEVICE AND DRIVING DISPLAY METHOD THEREOF

(75) Inventors: Chengming He, Shenzhen (CN); Chiayin Hung, Shenzhen (CN); Chihsien Li, Shenzhen (CN)

(73) Assignee: SHENZHEN CHINA STAR OPTOELECTRONICS TECHNOLOGY CO., LTD., Shenzhen (CN)

(21) Appl. No.: 13/216,781

(22) Filed: Aug. 24, 2011

(30) Foreign Application Priority Data
Oct. 15, 2010 (CN) 201010509558.4

(51) Int. Cl. G06F 3/038; G09G 3/36

(52) U.S. Cl. 345/209; 345/87

(57) ABSTRACT

The present invention provides a liquid crystal display device and a driving display method thereof which firstly provides a first data signal; generates a driving control signal according to the first data signal that the driving control signal divides a first pixel to a N-th pixel of a pixel column into a first pixel group and a second pixel group according to the positive or negative polarity of each of pixel-voltages that are to be correspondingly received by the first pixel to the N-th pixel; orderly provides a scanning signal to the pixels of the first pixel group according to the driving control signal to activate the pixels of the first group one by one to input corresponding pixel-voltages thereto; and then orderly provides another scanning signal to the pixels of the second pixel group to activate the pixels of the second group one by one to input corresponding pixel-voltages thereto, so as to complete a frame of image display. The present invention not only uses polarity inversion to improve display quality, but also economizes power consumption.

### FIELD OF THE INVENTION

The present invention relates to a liquid crystal display device and a driving display method thereof, and more particularly to a liquid crystal display device and a driving display method thereof that economize power consumption and lower temperature of components thereof by changing an output sequence of data signals.

### BACKGROUND OF THE INVENTION

Driving voltages of pixel electrodes of a liquid crystal display device can be divided into two types of polarities. When the driving voltage of the pixel electrodes is higher than a voltage of a common electrode, the driving voltage is called driving voltage with positive polarity; when the driving voltage of the pixel electrodes is lower than a voltage of a common electrode, the driving voltage is called driving voltage with negative polarity. If liquid crystal is continuously driven by driving voltages with the same polarity, characteristics of liquid crystal molecules will fail after a certain time, and affect display quality of liquid crystal display device. Therefore, the driving voltages for liquid crystal molecules need to execute polarity inversion after every certain time-interval.

Such polarity inversion is a common technique in liquid crystal display device, and according to different rules, the inversion type may be divided into frame inversion, column inversion, row inversion, dot inversion and two-line inversion. For display quality of a liquid crystal display device, the more adjacent pixels changes oppositely in polarity, the less flicker feelings the display images will cause to naked eyes. Hence, most liquid crystal display devices are operated with dot inversion type. (i.e. each of the pixels is opposite to the adjacent pixels of up, down, left and right in voltage polarity)

However, polarity inversion of pixel driving voltages is controlled by a timing controller, and the timing controller can outputs control signals to a row driver and a column driver for the pixels to perform pixel-display and voltage polarity inversion. When the polarity of a driving voltage of a pixel changes more frequently, the control signals output by the timing controller outputs changes with a higher frequency, such that the column driver consumes more power, and driving chips that construct the column driver will be accompanied by an over-heating problem.

Hence, it is necessary to provide a liquid crystal display device and a driving display method thereof to overcome the problems existing in the conventional technology.

### SUMMARY OF THE INVENTION

A primary object of the invention is to provide a driving display method of a liquid crystal display device which orderly provides a scanning signal to pixels that is receiving pixel-voltages with a first polarity according to positive and negative polarities of the pixel-voltages that are to be received by a pixel column in advance, so at to activate the pixels to correspondingly receive the pixel-voltages; and activates pixels receiving pixel-voltages with a second polarity by the same manner, so that inversion frequency of polarity of pixel-voltages outputted by the data driving circuit of the pixels can be reduced to economize power consumption and lower component temperature.

A secondary object of the present invention is to provide a liquid crystal display which applies the foregoing driving display method to change output order of pixel-voltages, so that in the pixel-voltages that are to be correspondingly inputted to pixels of a pixel column, the pixel-voltages with an identical polarity (positive or negative) are orderly inputted to the corresponding pixels; and the pixel-voltages with the other identical polarity then are orderly inputted to the corresponding pixels. As a result that inversion frequency of polarity of voltage is reduced, so as to economize power consumption.

To achieve the above object, the present invention provides a driving display method of a liquid crystal display device used in a liquid crystal display device having a plurality of pixel columns, and the driving display method of the liquid crystal display device comprises steps of:

providing a first data signal, wherein the first data signal determines pixel-voltages that are to be received by a first pixel to a N-th pixel in one of the pixel columns and determines polarity of positive or negative for each of the pixel-voltages that are to be received by the first pixel to the N-th pixel;

generating a driving control signal according to the first data signal, wherein the driving control signal divides the first pixel to the N-th pixel into a first pixel group and a second pixel group according to the positive or negative polarity of each of the pixel-voltages that are to be correspondingly received by the first pixel to the N-th pixel;

driving a first pixel group according to the driving control signal, wherein the pixels of the first pixel group are orderly provided with a scanning signal, so that the pixels of the first group are activated one by one to receive corresponding pixel-voltages; and

driving a second pixel group according to the driving control signal, wherein the pixels of the second pixel group are orderly provided with a scanning signal, so that the pixels of the first group are activated one by one to receive corresponding pixel-voltages.

Moreover, the present invention further provides a liquid crystal display device which comprises:

a plurality of pixel columns, wherein each of the pixel columns includes N pixels;

a timing controller, wherein the timing controller is used to receive and process a first data signal to further generate a driving control signal, wherein the first data signal determines pixel-voltages that are to be received by a first pixel to a N-th pixel in one of the pixel columns and determines polarity of positive or negative for each of the pixel-voltages that are to be received by the first pixel to the N-th pixel; and the driving control signal divides the first pixel to the N-th pixel into a first pixel group and a second pixel group according to the positive or negative polarity of each of the pixel-voltages that are to be correspondingly received by the first pixel to the N-th pixel;

a scanning driving circuit having a plurality of scanning lines, wherein each of the scanning lines is correspondingly connected to the pixels of the pixel columns that are positioned in an identical row, and the scanning driving circuit is connected to the timing controller and orderly provides a scanning signal to each of the pixels of the first pixel group according to the driving control signal, and then orderly provides another scanning signal to each of the pixels of the second pixel group; and

a data driving circuit having a plurality of data lines, wherein each of the data lines crosses the scanning lines and is correspondingly connected to all of the pixels of one of the pixel columns, and the data driving circuit is connected to the timing controller and orderly inputs pixel-voltages to the pixels of the first pixel group, correspondingly; and then orderly inputs pixel-voltages to the pixels of the second group, correspondingly.

In one embodiment of the present invention, the pixel-voltages that are to be correspondingly received by the pixels of the first pixel group are in positive polarity; and the pixel-voltages that are to be correspondingly received by the pixels of the second pixel group are in negative polarity.

In one embodiment of the present invention, the pixel-voltages that are to be correspondingly received by the pixels of the first pixel group are in negative polarity; and the pixel-voltages that are to be correspondingly received by the pixels of the second pixel group are in positive polarity.

In one embodiment of the present invention, a pixel matrix is constructed by the pixel columns, and the pixel matrix is applied with a polarity inversion means of dot inversion, row inversion or two-line inversion.

### DESCRIPTION OF THE DRAWINGS

FIG. 1 is a schematic view of a liquid crystal display device according to a preferred embodiment of the present invention;

FIG. 2 is a flow chart of driving display method of the liquid crystal display device of the present invention;

FIG. 3 is a time sequence diagram of output signals of data line D1 and scan lines G1 to G6 according to a prior art; and

FIG. 4 is a time sequence diagram of output signals of data line D1 and scan lines G1 to G6 according to the present invention.

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

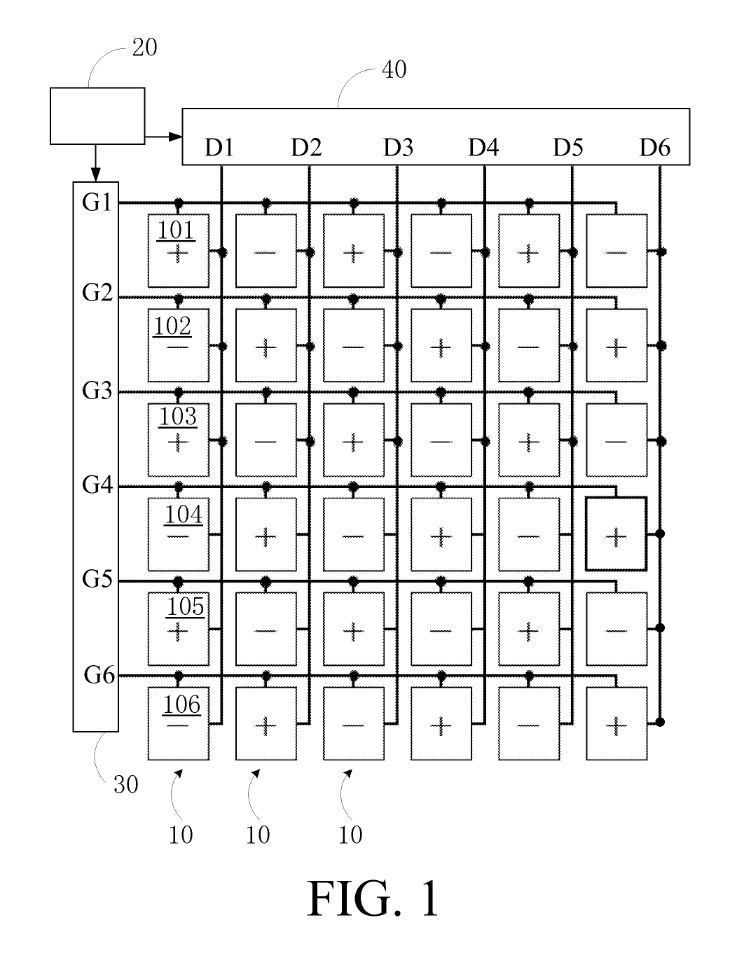

With reference to FIG. 1, FIG. 1 is a schematic view of a liquid crystal display device according to a preferred embodiment of the present invention. A liquid crystal display device comprises a plurality of pixel columns 10, a timing controller 20, a scanning driving circuit 30 and a data driving circuit.

Each of the pixel columns 10 includes N pixels, in the embodiment, one of the pixel columns 10 includes pixels of 101 to 106. A pixel matrix is constructed by the pixel columns 10. The pixel matrix may be applied with a polarity inversion means of dot inversion, row inversion or two-line inversion.

The timing controller 20 is used to receive and process a first data signal to further generate a driving control signal. The first data signal is an existing video signal inputted from outside, and can determine pixel-voltages (i.e. data-voltage, display-voltage) that are to be received by a first pixel to a N-th pixel in one of the pixel columns 10, and can determine polarity of positive or negative for each of the pixel-voltages that are to be received by the first pixel to the N-th pixel. In the embodiment, the first data signal determines polarity of positive for the pixels of odd numbers 101, 103, 105 of the first column of the pixel columns 10, and determines polarity of negative for the pixels of even numbers 102, 104, 106 of the first one of pixel columns 10. The driving control signal divides the first pixel to the N-th pixel into a first pixel group and a second pixel group according to the polarity of positive/negative of each of pixel-voltages that are to be correspondingly received by the first pixel to the N-th pixel. In detail, the pixel-voltages that are to be correspondingly received by the pixels of the first pixel group may be positive or negative in polarity. And the pixel-voltages that are to be correspondingly received by the pixels of the second pixel group are opposite in polarity to the pixel-voltages that are to be correspondingly received by the pixels of the first pixel group. In the embodiment, the driving control signal selects the pixels 101, 103, 105 that are to receive pixel-voltages with positive polarity as the first pixel group (i.e. the pixels of odd numbers 101, 103, 105 of the first column of the pixel columns 10); and the pixels 102, 104, 106 that are to receive pixel-voltages with negative polarity as the second pixel group (i.e. the pixels of even numbers 102, 104, 106 of the first column of the pixel columns 10)

The scanning driving circuit 30 is connected to the timing controller 20 and is constructed by a plurality of scanning driving chips (not illustrated). The scanning driving circuit 30 is connected to a plurality of scanning lines G1 to G6. Each of the scanning lines G1 to G6 is correspondingly connected to the pixels of the pixel columns 10 that are positioned in an identical row. The scanning driving circuit 30 orderly provides a scanning signal to each of the pixels 101, 103, 105 of the first pixel group according to the driving control signal, and then orderly provides another scanning signal to each of the pixels 102, 104, 106 of the second pixel group.

The data driving circuit 40 is connected to the timing controller 20 and constructed by a plurality of data driving chips (not illustrated). The data driving circuit 40 is connected to a plurality of data lines D1 to D6. Each of the data lines D1 to D6 crosses the scanning lines G1 to G6 and is correspondingly connected to all of the pixels of one of the pixel columns 10. The data driving circuit 40 orderly inputs pixel-voltages to the pixels 101, 103, 105 of the first pixel group, correspondingly; and then orderly inputs pixel-voltages to the pixels 102, 104, 106 of the second group, correspondingly, and thereby the pixels display an image.

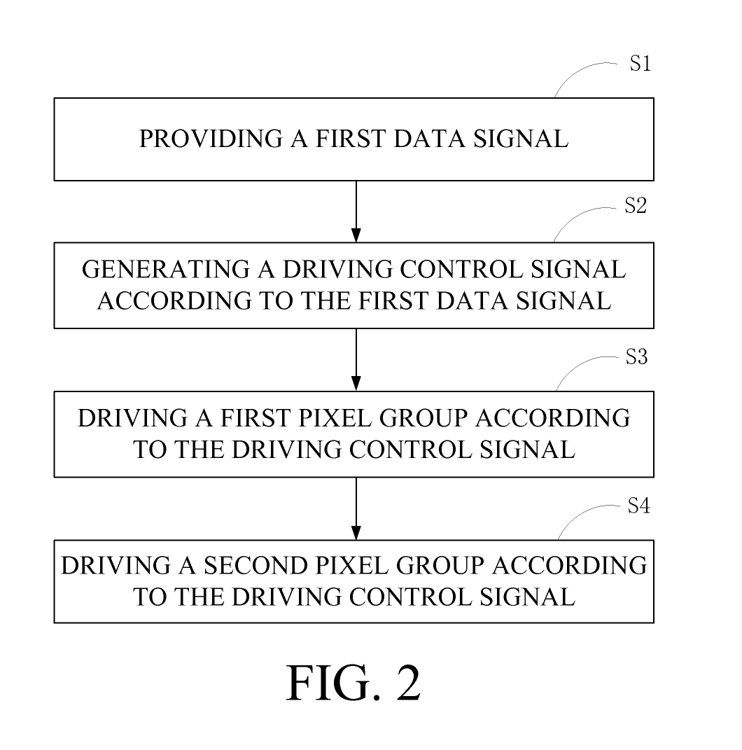

From the above, with reference to FIG. 2, a driving display method of a liquid crystal display device in accordance with the present invention comprises steps of:

providing a first data signal (S1), wherein the first data signal determines pixel-voltages that are to be received by a first pixel to a N-th pixel in one of the pixel columns 10 and determines polarity of positive or negative for each of the pixel-voltages that are to be received by the first pixel to the N-th pixel;

generating a driving control signal according to the first data signal (S2), wherein the driving control signal divides the first pixel to the N-th pixel into a first pixel group and a second pixel group according to the positive or negative polarity of each of the pixel-voltages that are to be correspondingly received by the first pixel to the N-th pixel;

driving a first pixel group according to the driving control signal (S3), wherein the pixels of the first pixel group are orderly provided with a scanning signal, so that the pixels of the first group are activated one by one to receive corresponding pixel-voltages; and
driving a second pixel group according to the driving control signal (S4), wherein the pixels of the second pixel group are orderly provided with a scanning signal, so that the pixels of the first group are activated one by one to receive corresponding pixel-voltages.

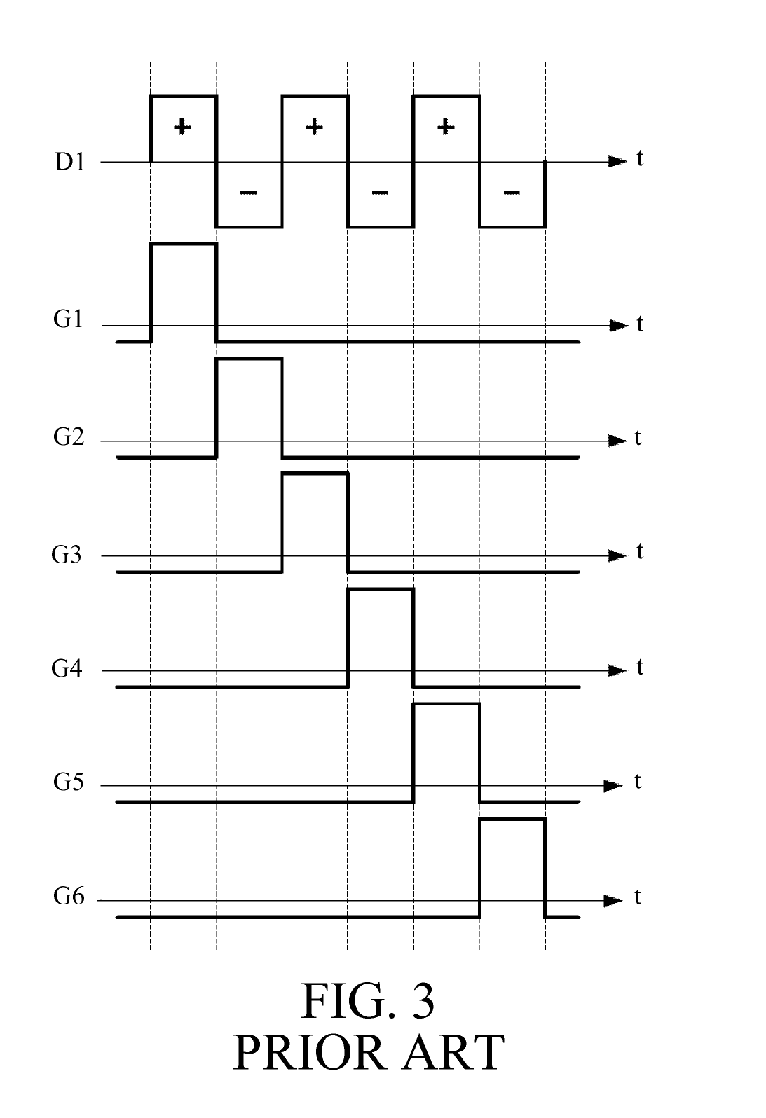

With reference to FIG. 3, FIG. 3 is a time sequence diagram of output signals of data line D1 and scan lines G1 to G6 according to a prior art, wherein the scanning driving circuit 30 orderly provides a scanning signal to the correspondingly-connected pixels in a top-down order of the scanning lines, to activate the pixels. The data driving circuit 40 then corresponds to the scanning signal of each of the pixels to simultaneously provide pixel-voltages thereto, so that the activated pixels can be charged to display an image, wherein the pixel-voltages of the adjacent pixels are opposite to each other in polarity, so as to improve flicker problem of display. Therefore, the pixel-voltages provided by the data line D1 need to be changed in polarity by pixel, which means the pixel-voltages need to be changed at every ⅙ frame of time-interval.

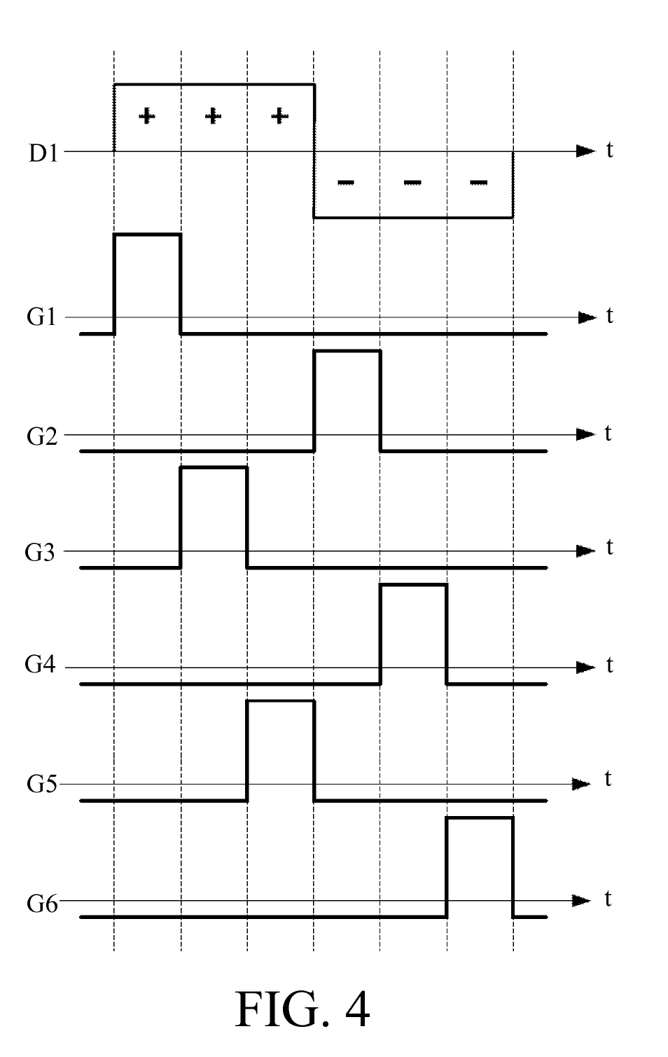

With further reference to FIG. 4, FIG. 4 is a time sequence diagram of output signals of data line D1 and scan lines G1 to G6 according to the present invention. The first data signal is processed by the timing controller 20 to become the driving control signal, and is inputted to the scanning driving circuit 30 and the data driving circuit 40. The scanning driving circuit 30 first orderly provides a scanning signal to the correspondingly connected pixels 101, 103, 105 through the scanning lines G1, G3, G5 in an order of the pixels that are to receive pixel-voltages in positive polarity according to the driving control signal to activate the correspondingly-connected pixels 101, 103, 105; and then provides another scanning signal to the correspondingly connected pixels 102, 104, 106 through the scanning lines G2, G4, G6 in an order of the pixels that are to receive pixel-voltages in negative polarity to activate the correspondingly connected pixels 102, 104, 106. The data driving circuit 40 corresponds to the scanning signal of each of the pixels to simultaneously provide pixel-voltages thereto through the data line D1, so that the activated pixels can be charged to display an image. Since the data driving circuit 40 orderly provides pixel-voltages in positive polarity to corresponding pixels 101, 103, 105, and then provides pixel-voltages in negative polarity to corresponding pixels 102, 104, 106, therefore the pixel-voltages just need to be changed in polarity at every ½ frame of time-interval (from positive polarity to negative polarity; or from negative polarity to positive polarity).

Similar to the driving means for the data line D1, the scanning lines G1, G3, G5, G2, G4, G6 also simultaneously provides a scanning signal to the pixels connected to the other data lines D2 to D6 in order, so as to activate the pixels row by row. The data driving circuit 40 corresponds to the scanning signal of each pixel to simultaneously provide pixel-voltage through the data lines D2 to D6, so that the activated pixels can be charged to display an image, and further complete a full display of image for the liquid crystal display device. The number of the data lines and the scanning lines does not limit the present invention; pixels of a liquid crystal display device can be driven according to the aforementioned rule.

Under an identical object of maintaining the adjacent pixels to be opposite to each other in polarity to improve flicker problem of image display, changing frequency of outputting pixel-voltages of the data driving circuit 40 is significantly lowered, so as to economize power consumption and also prevent data driving chips from overheating. Because the present invention changes the output order of vertically scanning signals, therefore the present invention can be adapted to a polarity inversion means that is not column inversion type, such as dot inversion, row inversion or even two-line inversion.

The present invention mainly uses the timing controller 20 to change the signal output order of scanning driving circuit 30 and the data driving circuit 40. To a display image with a vertical scanning frequency of 60 Hz and a 1920×1080 screen resolution, the data driving circuit 40 originally has a polarity changing frequency of 60×1080/2=32.4 KHz. Through the present invention, the polarity changing frequency can be lowered to 60/2/2=15 Hz, therefore the power consumption of the data driving circuit 40 can be reduced, and the temperature of the internal data driving chips can be decreased, correspondingly.

The present invention has been described with a preferred embodiment thereof and it is understood that many changes and modifications to the described embodiment can be carried out without departing from the scope and the spirit of the invention that is intended to be limited only by the appended claims.

1. A driving display method of a liquid crystal display device used in a liquid crystal display device having a plurality of pixel columns, characterized in that: a pixel matrix is constructed by the pixel columns, and the pixel matrix is applied with a polarity inversion means of dot inversion, row inversion or two-line inversion, and the driving display method comprises steps of:
providing a first data signal, wherein the first data signal determines pixel-voltages that are to be received by a first pixel to a N-th pixel in one of the pixel columns and determines polarity of positive or negative for each of the pixel-voltages that are to be received by the first pixel to the N-th pixel;
generating a driving control signal according to the first data signal, wherein the driving control signal divides the first pixel to the N-th pixel into a first pixel group and a second pixel group according to the positive or negative polarity of each of the pixel-voltages that are to be correspondingly received by the first pixel to the N-th pixel;
driving a first pixel group according to the driving control signal, wherein the pixels of the first pixel group are orderly provided with a scanning signal, so that the pixels of the first group are activated one by one to receive corresponding pixel-voltages; and
driving a second pixel group according to the driving control signal, wherein the pixels of the second pixel group are orderly provided with a scanning signal, so that the pixels of the first group are activated one by one to receive corresponding pixel-voltages.

2. A driving display method of a liquid crystal display device used in a liquid crystal display device having a plurality of pixel columns, characterized in that: the driving display method comprises:
providing a first data signal, wherein the first data signal determines pixel-voltages that are to be received by a first pixel to a N-th pixel in one of the pixel columns and determines polarity of positive or negative for each of the pixel-voltages that are to be received by the first pixel to the N-th pixel;
generating a driving control signal according to the first data signal, wherein the driving control signal divides the first pixel to the N-th pixel into a first pixel group and a second pixel group according to the positive or negative polarity of each of the pixel-voltages that are to be correspondingly received by the first pixel to the N-th pixel;
driving a first pixel group according to the driving control signal, wherein the pixels of the first pixel group are orderly provided with a scanning signal, so that the pixels of the first group are activated one by one to receive corresponding pixel-voltages; and
driving a second pixel group according to the driving control signal, wherein the pixels of the second pixel group are orderly provided with a scanning signal, so that the pixels of the first group are activated one by one to receive corresponding pixel-voltages.

3. The driving display method as claimed in claim 2, characterized in that: the pixel-voltages that are to be correspondingly received by the pixels of the first pixel group are in positive polarity; and the pixel-voltages that are to be correspondingly received by the pixels of the second pixel group are in negative polarity.

4. The driving display method as claimed in claim 3, characterized in that: a pixel matrix is constructed by the pixel columns, and the pixel matrix is applied with a polarity inversion means of dot inversion, row inversion or two-line inversion.

5. The driving display method as claimed in claim 3, characterized in that: the pixels of the first pixel group are pixels of odd numbers; and the pixels of the second group are pixels of even numbers.

6. The driving display method as claimed in claim 2, characterized in that: the pixel-voltages that are to be correspondingly received by the pixels of the first pixel group are in negative polarity; and the pixel-voltages that are to be correspondingly received by the pixels of the second pixel group are in positive polarity.

7. The driving display method as claimed in claim 6, characterized in that: a pixel matrix is constructed by the pixel columns, and the pixel matrix is applied with a polarity inversion means of dot inversion, row inversion or two-line inversion.

8. The driving display method as claimed in claim 6, characterized in that: the pixels of the first pixel group are pixels of odd numbers; and the pixels of the second group are pixels of even numbers.

9. A liquid crystal display device, characterized in that: the liquid crystal display device comprises:
a plurality of pixel columns, wherein each of the pixel columns includes N pixels;
a timing controller, wherein the timing controller is used to receive and process a first data signal to further generate a driving control signal, wherein the first data signal determines pixel-voltages that are to be received by a first pixel to a N-th pixel in one of the pixel columns and determines polarity of positive or negative for each of the pixel-voltages that are to be received by the first pixel to the N-th pixel; and the driving control signal divides the first pixel to the N-th pixel into a first pixel group and a second pixel group according to the positive or negative polarity of each of the pixel-voltages that are to be correspondingly received by the first pixel to the N-th pixel;
a scanning driving circuit having a plurality of scanning lines, wherein each of the scanning lines is correspondingly connected to the pixels of the pixel columns that are positioned in an identical row, and the scanning driving circuit is connected to the timing controller and orderly provides a scanning signal to each of the pixels of the first pixel group according to the driving control signal, and then orderly provides another scanning signal to each of the pixels of the second pixel group; and
a data driving circuit having a plurality of data lines, wherein each of the data lines crosses the scanning lines and is correspondingly connected to all of the pixels of one of the pixel columns, and the data driving circuit is connected to the timing controller and orderly inputs pixel-voltages to the pixels of the first pixel group, correspondingly; and then orderly inputs pixel-voltages to the pixels of the second group, correspondingly.

10. The liquid crystal display device as claimed in claim 9, characterized in that:
the pixel-voltages that are to be correspondingly received by the pixels of the first pixel group are in positive polarity; and the pixel-voltages that are to be correspondingly received by the pixels of the second pixel group are in negative polarity.

11. The liquid crystal display device as claimed in claim 10, characterized in that: a pixel matrix is constructed by the pixel columns, and the pixel matrix is applied with a polarity inversion means of dot inversion, row inversion or two-line inversion.

12. The liquid crystal display device as claimed in claim 10, characterized in that: the pixels of the first pixel group are pixels of odd numbers; and the pixels of the second group are pixels of even numbers.

13. The liquid crystal display device as claimed in claim 9, characterized in that:
the pixel-voltages that are to be correspondingly received by the pixels of the first pixel group are in negative polarity; and the pixel-voltages that are to be correspondingly received by the pixels of the second pixel group are in positive polarity.

14. The liquid crystal display device as claimed in claim 13, characterized in that: a pixel matrix is constructed by the pixel columns, and the pixel matrix is applied with a polarity inversion means of dot inversion, row inversion or two-line inversion.

15. The liquid crystal display device as claimed in claim 13, characterized in that: the pixels of the first pixel group are pixels of odd numbers; and the pixels of the second group are pixels of even numbers.
